(19) United States
(12) Patent Application Publication
(10) Pub. No.: US 2010/0198751 A1
(43) Pub. Date: Aug. 5, 2010

(54) PLUG-IN HYBRID RECHARGE POWER SYSTEM

(75) Inventor: Charles J. Jacobus, Ann Arbor, MI (US)

Correspondence Address: GIFFORD, KRASS, SPRINKLE,ANDERSON & CITKOWSKI, P.C, PO BOX 7021, TROY, MI, 48007-7021, US

(73) Assignee: Cybernet Systems Corporation, Ann Arbor, MI (US)

(21) Appl. No.: 12/364,850

(22) Filed: Feb. 3, 2009

(51) Int. Cl. G06F 17/00

(52) U.S. Cl. 705/412

(57) ABSTRACT

A system for recharging an electric or hybrid electric vehicle includes an interface enabling a user to obtain electrical power for vehicle recharging purposes, authentication apparatus, and a power control unit operative to deliver power from a source of power to the interface but only after the user has been approved by the authentication apparatus. Power consumption circuitry is operative to determine how much electrical power has been provided through the interface, and a data repository is used for storing the amount of power consumed on a per-user basis, and for billing each user for that amount.

### FIELD OF THE INVENTION

This invention relates generally to electric vehicle recharging and, in particular, to a system that provides paid-for recharging at an existing or new business, public facilities, or retail establishments for users who require recharging to make the trip from the establishment back to their points of origin or other destinations.

### BACKGROUND OF THE INVENTION

Emerging electric vehicles and plug-in hybrid electric vehicles provide a cost effective, energy efficient alternative means for powering personal mobility.

At the current state-of-the-art in electric energy storage, these vehicles are able to provide ranges in the 30 to 100 mile range suitable for many personal commutes. However, the return trip will often require a recharge.

Recharging at home is no problem because the user can easily plug into his/her home general electric service. The electric service will bill the user for energy consumed metered through the same home service meter utilized for other home electric consumption.

However, when at the non-home destination, recharge power is supplied from sources, which are likely to be linked to a business, retail, or public services electric services accounts (“third parties”). The power consumed for a return trip is sufficiently large that the third parties will wish to bill the plug-in vehicle user for the power consumed.

Since this power recharging application will be an add-in to present electrical uses, the third parties that wish to extend this service will require a means to provide plug-in powered that is metered, associated with the power consuming user, and therefore billable to that user according to the selected means the third party chooses to employ for this billing.

Power metering for home residential and business uses has been in use for many years. These units are associated with facilities, are often manually read, and can be remotely read if they incorporate a means of communications to the central billing of the electric service provider. Power meters for the purposes of regulating power to a plug socket, for power surge protection, or for accumulating power usage statistics for power monitoring are also in the market as consumer items. However, such systems do not ‘close the loop’ to support power billing subdivision to a user.

### SUMMARY OF THE INVENTION

This invention resides in a system for recharging an electric or hybrid electric vehicle. The system enables retrofitting a vehicle recharging service at an existing or new business, public facilities, or retail establishments for users who require recharging to make the trip from the establishment back to their points of origin or other destinations.

The system includes an interface enabling a user to obtain electrical power for vehicle recharging purposes, authentication apparatus, and a power control unit operative to deliver power from a source of power to the interface but only after the user has been approved by the authentication apparatus. Power consumption circuitry is operative to determine how much electrical power has been provided through the interface, and a data repository is used for storing the amount of power consumed on a per-user basis, and for billing each user for that amount.

In the preferred embodiment the interface is a socket, though inductive charging may also be used. The power provided may be single- or multi-phase at 120, 220 or 240 VAC or DC power. The interconnection to the data repository may be hard-wired, or the system may incorporate a transceiver facilitating wireless communication. At least a portion of the interconnection to the data repository may be carried out over a power-line network.

The authentication apparatus may accept a card, token, key, fingerprint or other appropriate form of ID. The interface, authentication apparatus, the power control unit and power consumption circuitry may be housed in an enclosure including a plug for insertion into a socket connected to the source of power, with a transceiver in the enclosure being provided for communicating wirelessly to the data repository.

### BRIEF DESCRIPTION OF THE DRAWINGS

FIG. 1 shows an electric vehicle recharging arrangement according to the invention;

FIG. 2 shows the detailed implementation of the Socket Assembly (2) of FIG. 1;

FIG. 3. shows how a system supporting multiple vehicle under recharge might be assembled;

FIG. 4 illustrates how the invention may be implemented in a portable or temporary manner; and

FIG. 5 illustrates how the invention may be implemented with an enclosure including a plug for insertion into a power outlet.

### DETAILED DESCRIPTION OF THE INVENTION

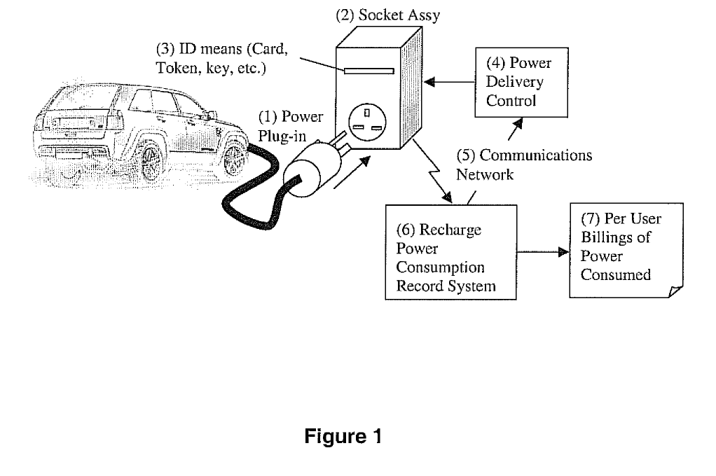

FIG. 1 shows an electric vehicle recharging arrangement according to the invention. The basic requirements are (1) a plug socket that (2) incorporates a power meter that (3) in turn is connected by a communications means to a data repository. The repository is (4) associated with a user (by account number, user name, payment identifier, vehicle VIN, or other user identifying means), and (5) therefore a means of user billing. “Vehicle” should be taken to mean any type of rechargeable transportation including cars, trucks, electric scooters, motorcycles, motor homes, etc.

Recharging Power plug (1) from the vehicle is inserted into a Socket in Socket Assembly (2) to provide recharge power to the vehicle. An alternative transfer approach is to utilize wireless transfer as described by Baarman, et al., the entire content of which is incorporated by reference. In this alternative approach, the vehicle is positioned in a parking space so that the vehicle's power receive coil is in the proper position relative to the parking space power transmit coil.

Power transfer is not initiated until the user authenticates. In FIG. 1 this is done by presenting a magnetic ID card (3) to the ID means shown on the Socket Assembly (2). In an alternative implementation the ID/Authentication function might be implement as a (a) smart card, credit card or debit card, where the control computer in the socket reads the ID information from the card when the card is inserted, (b) fingerprint reader where the user presents one or more fingers or thumb to the reader for authentication, (c) proximity RF identification device which is read from near the socket to authenticate, (d) closed circuit video that read an aspect of the user's appearance for presentment to an authentication authority (either manual or via an automated recognition system), (e) key pad where the user types in a pre-established key code for identification, or (f) any other appropriate ID/authentication mechanism.

Upon authentication a user record is initiated within the Recharge Power Consumption Record System (6), and signals are sent to the Power Delivery Control (4) to initiate power flow into the vehicle connected for recharging. As the vehicle recharges, current flows into the vehicle and when fully recharged, the current flow essentially stops. Alternatively, the user may terminate the recharging process early if/when it is known that the charge level is sufficient for the next destination, or the user may only want to spend a certain amount of money for the recharge, in which case that amount would be entered by the user prior to charging. The Recharge Power Consumption Record System (6) keeps a record of this Per User Billing of Power (7) based on the amount consumed for recharging over any predetermined session or period. Then the system operator bills the user as the operator sees fit to recover the cost of the power consumed recharging the user's vehicle.

The communications to a central computer unit allows accumulation of the power utilization statistical information. Some such communication may include but is not limited to: (1) Wireless protocols that transmit power utilization data over the air from the point of power consumption, (2) Data-over-power line protocols that transmit power utilization data over the air from the point of power consumption, (3) Data over cellular phone protocols that transmit power utilization data over the air from the point of power consumption, or (4) Hardwired data to send power utilization data from the power consumption point.

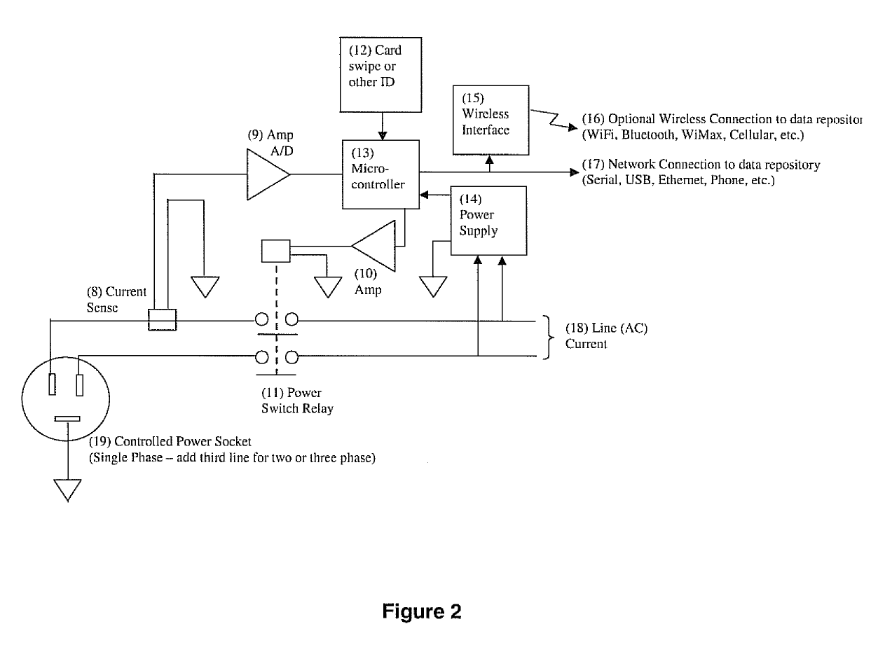

FIG. 2 shows the detailed implementation of the Socket Assembly (2) of FIG. 1. Power to the socket (19) is routed through a switch (11) that is controlled by the system so that recharge cannot be done for an unauthorized vehicle. The wiring shown through the switch (11) from the AC Line (18) is for 120 VAC single-phase. Some vehicle systems might be supplied by 220 three phase or 240 VAC or power already converted to DC current ()C Power). The concept stays the same except that the additional power requirements may be switched.

Current being drawn into the vehicle for recharging is sensed (8), buffered as needed (9), and is read into a microcontroller (13). This microcontroller also is connected to or includes authentication means. A charging session is initiated when the user successfully authenticates to the Socket Assy. The microcomputer, upon successful authentication, switches power through the vehicle (via (10) control to the switch relay (11)), and senses current flow (via current sensor (8)). Although only single-phase sensing is shown, those of skill in the art will appreciate that additional current sensors could be included in multiphase systems if deemed necessary for accuracy.

The recharging session continues until either the vehicle is fully recharged and current flow approaches zero, or the socket plug-in is pulled, disconnecting the vehicle (and thus terminating recharging). The power consumed by the recharge session is the integral of the current flow (i.e. the sum of current measurements per unit time) times the recharge voltage and is measure in lilowatt-hours (or equivalent energy measure). This energy-consumed measure is relayed to the data repository through the data network interfaces utilized (including Wireless (15), Hardwired, (17) or data over power line networks).

Also shown in FIG. 2, the Socket Assembly logic for control and authentication is powered from the same AC current source as the vehicle recharge (14). Alternatives exist which include powering logic from batteries, solar panels, or an external low voltage power source. Furthermore, the authentication component (11), power controls (8, 9, 10, and 11), and control computer (13, 14, 15) might be located in a different assembly from the actual power socket (19). For instance at a business premises, the control elements might be located inside at a point of employee entry to be activated by application of the employee's employment card ID.

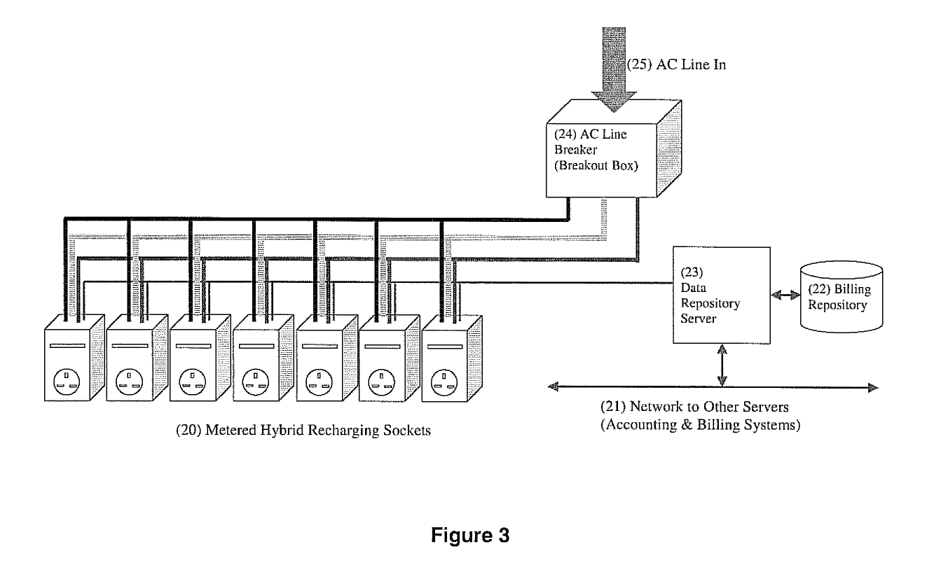

FIG. 3 shows how a system supporting multiple vehicles under recharge might be assembled. AC power portion of the (20) Metered Hybrid Recharging Sockets (Socket Assemblies) are wired the same as would be done with normal un-metered power sockets. The wiring shown in FIG. 3 is for 120 VAC wiring with Black high wire, White common, and Green Earthen ground from a distribution and breaker box (24) fed from line in (25). 240 VAC would be similar replacing the white common with the alternate 120 VAC high line. Three-phase 220 would bring out three phases and a ground in a four-wire bundle.

The data network is depicted as a common line from each plug. This is a possible wiring approach if the data bus used is RS 485 multidrop serial. Other multidrop networks can be substituted. Alternatively, each socket can support a wireless protocol like 802.11 or 802.15, Zigbee. As a further alternative, a chain bus like USB or CAN may be substituted. Regardless, each socket is logically connected to the network bring data to the Data Repository Server (23). This server keeps user authentication data in the Billing Repository (22) (or provides access to this data on an upper echelon server connected through via (21) Network), provides the user authentication function, keeps vehicle recharge power consumption data records in the Billing Repository (22) (or forwards this data to an upper echelon server connected through via Network (21)), initiates user billing (or provides data from upper echelon servers that perform this function via Network (21)) and controls the power on/off function of each Metered Hybrid Recharging Socket (20).

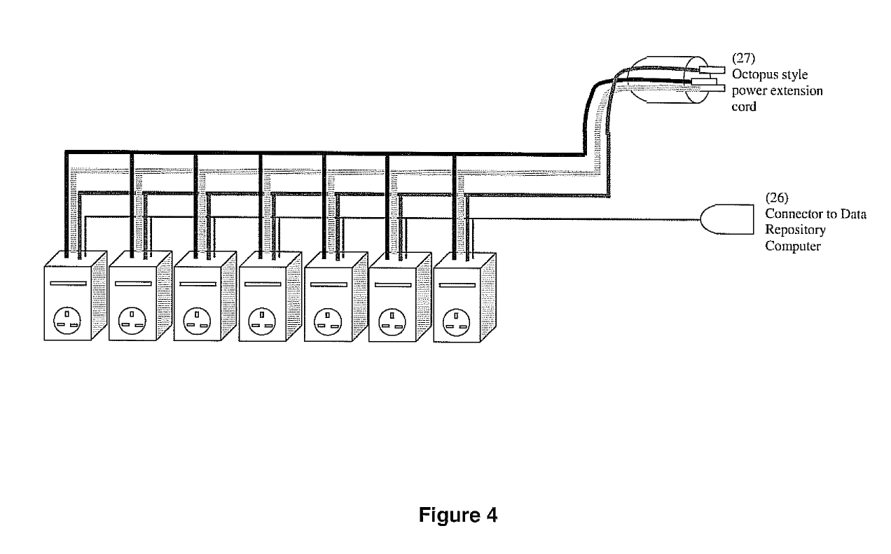

FIG. 3 can be implemented in a portable or temporary manner as shown in FIG. 4. In this arrangement, the data component is inserted into a business computer (26), which is on the network, and each power plug (27) is an element of an Octopus style power extension cord. This type of arrange might be used as a retrofit to a facility where installing a more permanent system by electrician is either not timely or too costly.

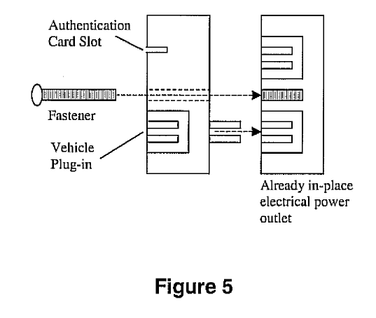

Another alternative implementation is shown in FIG. 5. This version plugs directly into an already wired electrical outlet. Network connectivity is via data over power line or wireless, which powered is directly from the electrical outlet.

Having described my invention, I claim:

1. A system for recharging an electric or hybrid electric vehicle, comprising:
an interface enabling a user to obtain electrical power for vehicle recharging purposes;
authentication apparatus;
a power control unit operative to deliver power from a source of power to the interface but only after the user has been approved by the authentication apparatus;
power consumption circuitry operative to determine how much electrical power has been provided through the interface; and
a data repository for storing the amount of power consumed on a per-user basis, and for billing each user for that amount.

2. The system of claim 1, wherein the interface is a socket.

3. The system of claim 1, wherein the interface is inductive.

4. The system of claim 1, wherein the power is single- or multi-phase at 120, 220 or 240 VAC.

5. The system of claim 1, wherein the power is DC power.

6. The system of claim 1, wherein the interconnection to the data repository is hard-wired.

7. The system of claim 1, further including a transceiver facilitating wireless communication with the data repository.

8. The system of claim 1, wherein at least a portion of the interconnection to the data repository is over a power-line network.

9. The system of claim 1, wherein the authentication apparatus accepts a card, token, key or fingerprint.

10. The system of claim 1, wherein:
the interface, authentication apparatus, the power control unit and power consumption circuitry are housed in an enclosure including a plug for insertion into a socket connected to the source of power; and
a transceiver in the enclosure for communicating wirelessly to the data repository.

11. The system of claim 1, including a plurality of interfaces enabling multiple users to recharge different vehicles at the same time.

12. A system for recharging an electric or hybrid electric vehicle, comprising:
an enclosure;
a socket on the enclosure enabling a user to plug in a vehicle for recharging purposes;
authentication apparatus disposed on the enclosure;
a power control unit within the enclosure operative to deliver power from a source of power to the socket but only after the user has been approved by the authentication apparatus;
power consumption circuitry within the enclosure to determine how much electrical power has been provided through the socket; and
a data repository remote from the enclosure for storing the amount of power consumed on a per-user basis, and for billing each user for that amount.

13. The system of claim 12, wherein the power is single- or multi-phase at 120, 220 or 240 VAC.

14. The system of claim 12, wherein the power is DC power.

15. The system of claim 12, wherein the interconnection to the data repository is hard-wired.

16. The system of claim 12, further including a transceiver facilitating wireless communication with the data repository.

17. The system of claim 12, wherein at least a portion of the interconnection to the data repository is over a power-line network.

18. The system of claim 12, wherein the authentication apparatus accepts a card, token, key or fingerprint.

19. The system of claim 12, wherein:
the enclosure includes a plug for insertion into a socket connected to the source of power; and
a transceiver within the enclosure for communicating wirelessly to the data repository.
